(19) United States
(12) Patent Application Publication
(10) Pub. No.: US 2014/0339221 A1
(43) Pub. Date: Nov. 20, 2014

(54) ELECTRIC INDUCTION GAS-SEALED TUNNEL FURNACE

(71) Applicant: Jean Lovens, Embourg (BE)

(72) Inventor: Jean Lovens, Embourg (BE)

(73) Assignee: Inductotherm Corp., Rancocas, NJ (US)

(21) Appl. No.: 14/344,776

(22) PCT Filed: Sep. 15, 2012
(86) PCT No.: PCT/US12/55668

§ 371 Date: Mar. 13, 2014

Related U.S. Application Data
(60) Provisional application No. 61/535,643, filed on Sep. 16, 2011.

(51) Int. Cl. F27B 9/04; F27B 9/36; F27D 11/06; F27B 9/28

(52) U.S. Cl. CPC F27B 9/04; F27B 9/28; F27B 9/36; F27D 11/06
USPC 219/645; 219/651; 219/653; 29/428

(57) ABSTRACT

A reinforced electric induction gas sealed tunnel furnace is provided. The assembled tunnel furnace has a tunnel wall that has the exterior wall transversely surrounded by structural reinforcing elements that give the tunnel structural strength to withstand a pressure differential between the interior and exterior of the tunnel, for example, when the tunnel interior environment is a vacuum and the tunnel exterior environment is at atmospheric pressure. One or more inductors form the induction coil system for the N tunnel furnace and can be located external to the tunnel wall, but within or adjacent to, the structural reinforcing elements. In alternative arrangements the structural reinforcing elements may be oriented with the length of the tunnel and installed either within or external to the tunnel. The tunnel and the structural reinforcing elements are sufficiently electromagnetically transparent to not interfere with inductive heating of a strip passing through the tunnel.

### CROSS REFERENCE TO RELATED APPLICATIONS

This application claims the benefit of U.S. Provisional Application No. 61/535,643 filed Sep. 16, 2011, which is hereby incorporated by reference in its entirety.

### FIELD OF THE INVENTION

The present invention relates generally to electric induction gas-tight tunnel furnaces where continuous strips or discrete plates pass through a gas-sealed tunnel to be inductively heated, and in particular to such furnaces when the process environment within the tunnel through which the strip travels is at a different pressure than the environment exterior to the tunnel, for example when the process environment is at vacuum and the exterior environment is atmospheric pressure.

### BACKGROUND OF THE INVENTION

Industrial processes may require the heating of an electrically conductive material, such as a metal strip, in a vacuum. One method of accomplishing the heating of the strip in a vacuum is to install a conventional non-vacuum tight electric induction tunnel furnace within a vacuum chamber. In this industrial process, the inside of the furnace's tunnel (through which the strip travels) and the exterior of the tunnel are both maintained in the vacuum process environment. However this process requires expensive vacuum seal fittings for the electric power conductors that are fed into the vacuum chamber from an external source of alternating current (AC) power to the furnace's induction coil(s) within the chamber. Furthermore applied voltage to the coil(s) used in this process must be kept at a low level (for example, 300 V) to avoid ionization in the vacuum environment. Consequently extremely high magnitude currents must be maintained for industrial applications requiring high electric power densities for inductive heating. The furnace wall of a conventional tunnel furnace cannot withstand the pressure differential between the vacuum process environment within the tunnel and atmospheric pressure applied to the exterior of the furnace wall (either directly or indirectly, through one or more intermediate enclosing structures at atmospheric pressure). A conventional induction furnace tunnel wall can be constructed from a fiberglass fabric with thermal insulation installed on the interior of the tunnel wall. An electromagnetically transparent composition, such as a fiberglass fabric is used so that the furnace inductor(s) can be installed around the exterior of the furnace wall. Industrial vacuum environments can be greater than 10⁻⁸ torr and exert a force on the tunnel's wall that can be on the order of ten metric tons per square meter. Conventional heavy weight and volume consuming structural reinforcing materials can be used to reinforce the exterior of the tunnel's wall to withstand the internal vacuum environment when the tunnel furnace is installed in a positive pressure environment such as atmospheric pressure. However the problem with these conventional reinforcing materials is that they restrict locating the furnace inductor(s) in close proximity to the heated strip (or other workpiece) within the tunnel.

It is one object of the present invention to provide a lightweight, non-electrically conductive reinforced electric induction gas-sealed tunnel furnace.

It is another object of the present invention to provide a lightweight, non-electrically conductive reinforced electric induction gas-sealed tunnel furnace for withstanding a pressure differential between the environment within the tunnel and the environment external to the tunnel.

It is another object of the present invention to provide an electric induction tunnel furnace for a sealed process environment within the tunnel that is at a different pressure than the pressure external to the tunnel, and the one or more inductors of the furnace are located external to the tunnel and adjacent to the structural elements of the furnace that reinforce the wall of the tunnel to withstand the pressure differential between the exterior and interior of the tunnel, so that distance between the inductor(s) and workpiece (such as a metal strip) within the tunnel is minimized to provide optimum flux coupling for induced heating of the workpiece in the tunnel's sealed process environment.

It is another object of the present invention to provide an electric induction tunnel furnace for a sealed process environment within the tunnel that is at a different pressure than the pressure external to the tunnel with: (1) the one or more inductors of the furnace located external to the tunnel and (2) the structural elements of the furnace that reinforce the wall of the tunnel (to withstand the pressure differential between the exterior and interior of the tunnel) located within the tunnel.

### BRIEF SUMMARY OF THE INVENTION

In one aspect the present invention is an apparatus for, and method of, heating an electrically conductive material passing through an electric induction furnace's gas-tight electromagnetically transparent tunnel where the furnace inductors are located exterior to the tunnel and a pressure differential is maintained between the interior and exterior of the tunnel. Electromagnetically transparent tunnel reinforcement structure is provided exterior to the tunnel for pressure differential withstand and the furnace inductors are provided within the tunnel reinforcement structure to minimize the distance between the inductors and the electrically conductive material passing through the interior of the tunnel so that induced magnetic flux produced by alternating current flow through the inductors achieves optimum coupling with the electrically conductive material.

In another aspect the present invention is an apparatus for, and method of, heating an electrically conductive material passing through an electric induction furnace's gas-tight electromagnetically transparent tunnel where the furnace inductors are located exterior to the tunnel and a pressure differential is maintained between the interior and exterior of the tunnel. Electromagnetically transparent tunnel reinforcement structure is provided interior to the tunnel for pressure differential withstand and the furnace inductors are provided around the exterior wall of the tunnel.

In another aspect the present invention is an apparatus for, and method of, heating an electrically conductive material passing through a gas-tight electromagnetically transparent tunnel that may be used in a vacuum process environment within the tunnel and a non-vacuum positive pressure environment external to the tunnel that may, for example, be atmospheric pressure.

The above and other aspects of the invention are set forth in this specification and the appended claims.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1(a) illustrates an induction furnace's tunnel wall that is joined and sealed to entry and exit flanges and is used in some examples of the present invention.

FIG. 1(b) illustrates a transverse reinforcing structural element that is used in some examples of the present invention.

FIG. 1(c) illustrates the tunnel furnace's wall in FIG. 1(a) joined to a plurality of the transverse reinforcing structural elements in FIG. 1(b) by L-shaped girding structural elements.

FIG. 1(d) illustrates the tunnel furnace's wall in FIG. 1(a) joined to a plurality of the transverse reinforcing structural elements shown in FIG. 1(b) by L-shaped girding structural elements with a single turn inductor positioned in each of the plurality of spaces between adjacent transverse reinforcing structural elements except for those spaces located at opposing entry and exit ends of the furnace.

FIG. 1(e) illustrates one example of an electric induction gas-sealed tunnel furnace of the present invention with optional end compensators that utilizes the plurality of transverse reinforcing structural elements and L-shaped girding structural elements shown in FIG. 1(b) through FIG. 1(d) with a single turn inductor positioned in each of the plurality of spaces between adjacent transverse reinforcing structural elements except for those spaces located at opposing entry and exit ends of the furnace.

FIG. 2(a) and FIG. 2(b) illustrate one example of an electric induction gas-sealed tunnel furnace of the present invention having a tunnel wall as shown in FIG. 1(a) with top, bottom and side exterior wall girding sheets having transverse girding strips periodically embedded in the sheets.

FIG. 2(c) illustrates one example of an electric induction gas-sealed tunnel furnace of the present invention that is referred to as the “modified example B” and is a modification of the furnace shown in FIG. 2(a) and FIG. 2(b).

FIG. 3(a) through FIG. 3(d) illustrate one example of an electric induction gas-sealed tunnel furnace of the present invention that is referred to as the “modified example A” and is a modification of the furnace components shown in FIG. 2(a) and FIG. 2(b), specifically:

FIG. 3(a) illustrates a transverse reinforcing structural element that is used in some examples of the present invention for modified example A;

FIG. 3(b) illustrates a plurality of transverse reinforcing structural elements shown in FIG. 3(a) installed over the top, bottom and side girding sheets and strips shown in FIG. 2(a) and FIG. 2(b) for modified example A;

FIG. 3(c) is a detail view of the arrangement shown in FIG. 3(b); and

FIG. 3(d) illustrates one example of an electric induction gas-sealed tunnel furnace of modified example A with optional end compensators that utilizes the girding sheets and strips, and transverse reinforcing structural elements shown in FIG. 2(a), FIG. 2(b), FIG. 3(a), FIG. 3(b) and FIG. 3(c) with a single turn inductor installed in each of the plurality of spaces between adjacent transverse reinforcing structural elements except for those spaces located at opposing entry and exit ends of the furnace.

FIG. 4(a) illustrates one example of an electric induction gas-sealed tunnel furnace of the present invention with optional end compensators that utilizes the box-shaped transverse girding structural elements shown in FIG. 4(b), FIG. 4(c) and FIG. 4(d).

FIG. 4(b) illustrates a box-shaped transverse girding structural element that is used in the tunnel furnace shown in FIG. 4(a) and FIG. 4(e).

FIG. 4(c) and FIG. 4(d) illustrate a plurality of the box-shaped transverse girding structural element shown in FIG. 4(b) surrounding the exterior of the furnace's tunnel wall as used in the tunnel furnace shown in FIG. 4(a) and FIG. 4(e).

FIG. 4(e) illustrates the electric induction gas-sealed tunnel furnace shown in FIG. 4(a) in an opposing side view to show a typical termination for the single turn inductor(s) that can be used in a tunnel furnace of the present invention.

FIG. 5(a) illustrates one example of an electric induction gas-sealed tunnel furnace of the present invention that utilizes longitudinally oriented reinforcing structural elements shown in FIG. 5(b) and FIG. 5(c) within the tunnel wall with two single turn inductors surrounding the exterior of the tunnel wall and optional end compensators.

FIG. 5(b) and FIG. 5(c) illustrate one example of the longitudinally oriented reinforcing structural elements used within the tunnel wall of the furnace shown in FIG. 5(a).

FIG. 5(d) and FIG. 5(e) illustrate one example of the flanges utilized in the furnace shown in FIG. 5(a).

FIG. 5(f) illustrates the interface between an end of the tunnel wall and longitudinally oriented reinforcing elements with each flange used in the furnace shown in FIG. 5(a).

FIG. 6(a) illustrates a furnace tunnel with longitudinally oriented reinforcing structural elements exterior to the tunnel wall in combination with girding structural elements wrapped transversely over the exterior longitudinally reinforcing structural elements.

FIG. 6(b) is a detail of the interface between furnace sealing flanges and the furnace tunnel wall with longitudinally oriented reinforcing structural elements located exterior to the tunnel wall.

FIG. 6(c) illustrates the furnace tunnel with longitudinally oriented reinforcing structural elements exterior to the tunnel wall shown in FIG. 6(a) without the girding structural elements wrapped transversely over the exterior longitudinally reinforcing structural elements.

FIG. 6(d) illustrates one example of the electric induction gas-sealed tunnel furnace of the present invention that utilizes longitudinally oriented reinforcing structural elements shown in

FIG. 6(a) through FIG. 6(c) exterior to the tunnel wall in combination with girding structural elements wrapped transversely over the exterior longitudinally reinforcing structural elements with two single turn inductors surrounding the exterior girding structural elements and optional end compensators.

FIG. 6(e) illustrates the electric gas-sealed tunnel furnace in FIG. 6(d) without the optional end compensators

### DETAILED DESCRIPTION OF THE INVENTION

Generally a preferred, but none limiting, fabrication of an electric induction gas-sealed tunnel furnace of the present invention can be described as follows where the reinforcement to the tunnel is achieved external to the tunnel. The terms “tunnel” and “tunnel wall” are used interchangeably. A tunnel wall of fiberglass fabric, or other electromagnetically transparent material, can be wound on a suitable tunnel mold for a curing process, or otherwise suitably formed. A tunnel reinforcement assembly can be formed from a plurality of tunnel reinforcing structural elements (or components), as illustrated by the examples below, from a fiberglass fabric, or other electromagnetically transparent composition, that can be formed from one or more tunnel reinforcement molds for a curing process, or otherwise suitably formed. The tunnel reinforcement molds may include an inductor volume mold for insertion of inductors around the exterior of the formed tunnel furnace and within the plurality of tunnel reinforcing structural elements. The dry cured tunnel and the plurality of tunnel reinforcing structural elements can then be assembled into the tunnel reinforcement assembly and resin-injected to impregnate the combined tunnel and tunnel reinforcement assemblies and form a reinforced gas-tight (or gas-sealed) furnace tunnel assembly. The tunnel mold is removed and the resulting volume forms the interior of the furnace tunnel. The inductor volume mold, if used, is removed from each of the plurality of tunnel reinforcing structural elements and the resulting inductor volume forms the location of one or more electric inductors (coils) for a reinforced gas-sealed electric induction tunnel furnace of the present invention. In some examples of the invention, typically, but not by way of limitation, at least one single turn inductor (coil) occupies each of the inductor volumes formed from each one of the plurality of tunnel reinforcing structural elements. The resulting arrangement of single turn coils may be electrically connected all in series; all in parallel; or in series-parallel combinations for connection to one or more AC power supplies. One or more of the volumes formed from the plurality of tunnel reinforcing structural elements may not contain an inductor (for example, volumes at the tunnel's opposing ends) to provide free space for the return path of electromagnetic flux established by AC current flow through the inductors; alternatively liquid cooled, electrically conductive (for example, copper) shields may be installed in these end volumes to contain the electromagnetic flux. Empty (without inductor) reinforcement inductor volumes may be provided anywhere along the length of the tunnel depending upon the requirements of a specific design.

Alternatively in other examples of the furnace of the present invention, coil volumes may be provided between adjacent reinforcing volumes for installation of at least one single turn inductor in one or more of the coil volumes. In other examples of the invention the furnace tunnel may be formed from a siliconized sleeve.

Alternatively to the furnace fabrication process described above, the plurality of tunnel reinforcing structural elements may be pre-impregnated fiberglass fabrics that are cured in an autoclave.

In some applications, the electric induction gas-sealed tunnel furnace may be installed in a vacuum environment process line. In other applications the furnace may be used as an isolated tunnel furnace with a suitable load vacuum sealing lock chamber (for example, as disclosed in U.S. Pat. No. 7,931,750 B2) connected to the entry and exit tunnel openings. When used as one component in a vacuum process line, the entry and exit openings of the tunnel may each be connected to a mechanical compensator (expansion joint) to accommodate axial thermal expansion or contraction that can result in an axial (X) direction compression force on the tunnel furnace, for example, in the range of 2 metric tons. In addition to withstand of the ambient pressure/vacuum differential on opposing outer and inner walls of the tunnel furnace, the reinforcing structural arrangements of the present invention also provide withstand of this axial compression force.

The following examples of the invention illustrate various electric induction gas-sealed tunnel furnaces of the present invention formed by the above fabrication processes, and variations and modifications thereto.

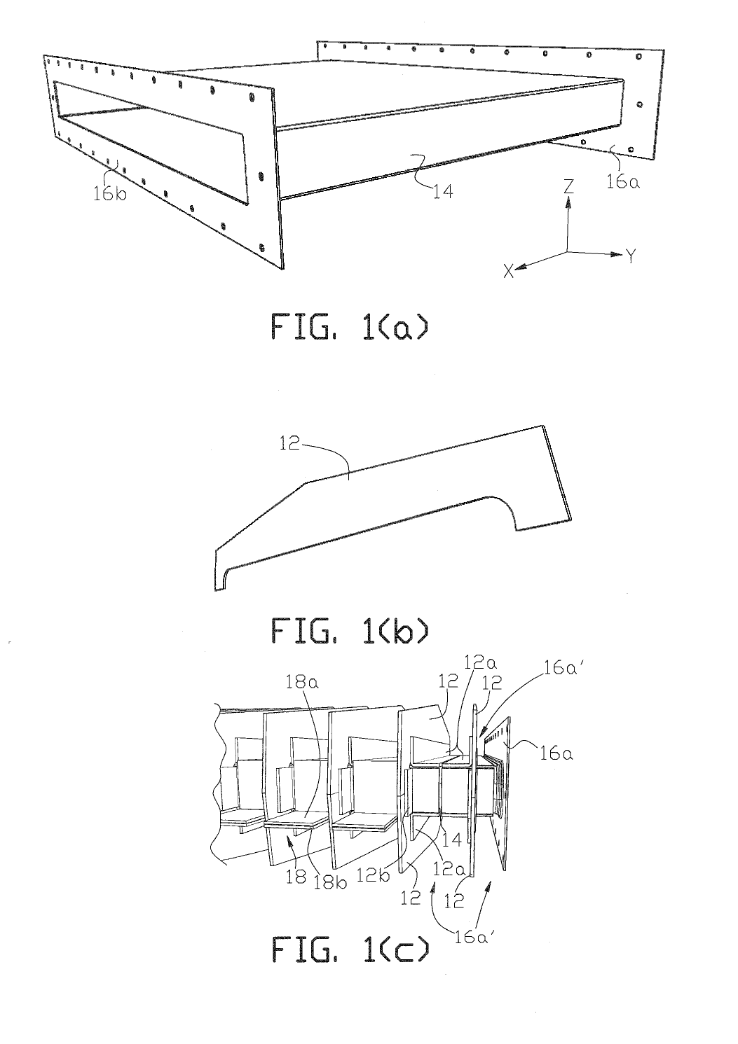

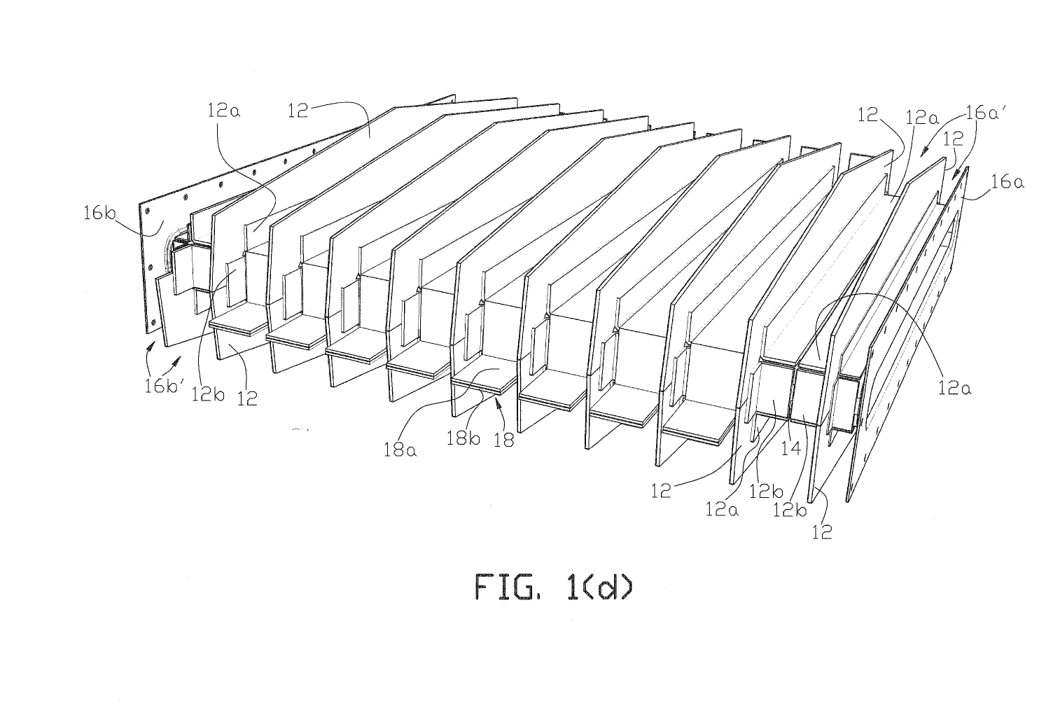

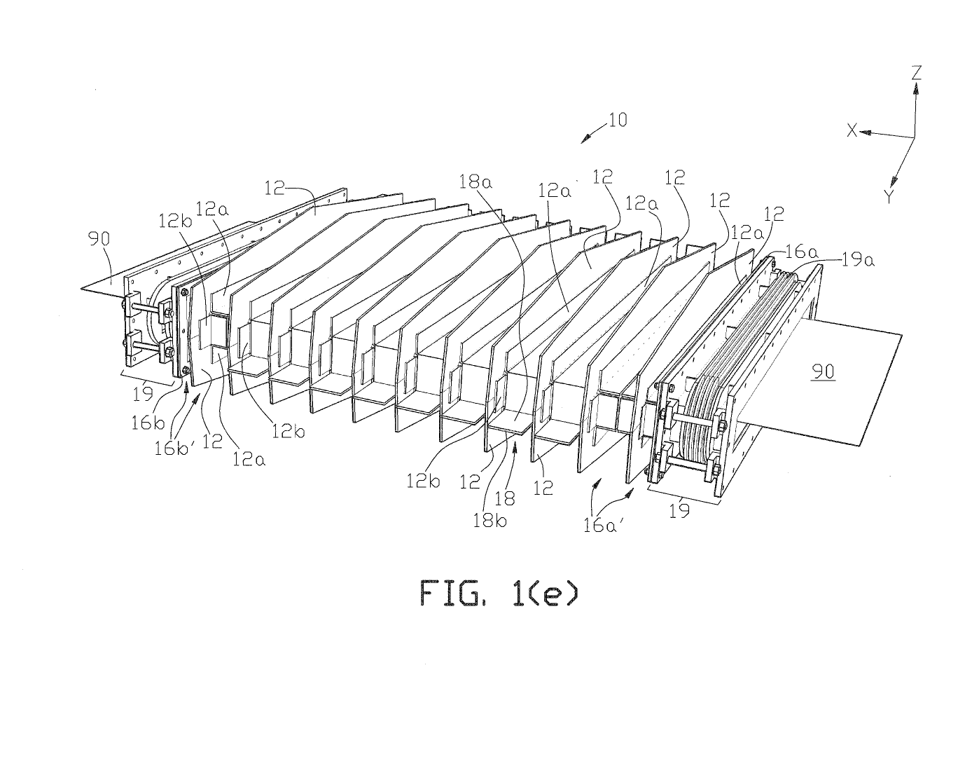

FIG. 1(a) through FIG. 1(e) illustrate one example of an electric induction gas-sealed tunnel furnace of the present invention. Furnace 10 (FIG. 1(e)) can utilize a furnace tunnel (or fuselage) wall 14 sealed to workpiece entry 16a and exit 16b end flanges as shown in FIG. 1(a). External reinforcing structural elements 12 that form a part of the tunnel reinforcement assembly are periodically disposed transversely (Y-direction) around the exterior of tunnel wall 14 as shown in FIG. 1(c), FIG. 1(d) and FIG. 1(e). Each individual element 12 is in cut-out sheet form as shown, for example, in FIG. 1(b) and transversely surrounds one-half of the exterior of the tunnel wall. Reinforcing (or girding) structural elements that form a part of the tunnel reinforcement assembly connect each side of each external reinforcing structural element 12 to the exterior of the tunnel wall to form a plurality of bands transversely girding the exterior of the gas-sealed furnace tunnel. In this example of the invention, as shown in the figures, each girding structural elements is “L”-shaped and comprises separate transverse (top and bottom) girding structural elements 12a and side girding structural elements 12b (located on each opposing side of tunnel wall 14). At least one single turn inductor 18 is disposed in the space between adjacent reinforcing structural elements 12 and over the portion of the L-shaped girding structural elements attached to the tunnel wall as shown in FIG. 1(c), FIG. 1(d) and FIG. 1(e), except (optionally) in the spaces 16a′ and 16b′ between one or more opposing end reinforcing structural elements 12 and entry 16a and exit 16b end flanges at the entry and exit ends of the furnace for reasons as generally explained above. In this example of the invention, each single turn inductor 18 comprises suitably interconnected upper 18a and lower 18b inductor sections that facilitate installation of each single turn inductor around the outside of the tunnel wall. Optional (thermal expansion elements or) compensators 19 (as shown in FIG. 1(e)) can be provided at the entry and/or exit ends of the tunnel furnace 10 to allow for thermal expansion and contraction in the axial (X) direction. Each compensator can include a sealed bellows element 19a that expands or contracts in the axial direction in response to thermal gradients. Metal strip 90 is shown in FIG. 1(e) as the workpiece passing through the tunnel furnace so that when the single turn inductor(s) are suitably connected to one or more AC power sources the metal strip will be inductively heated within the tunnel.

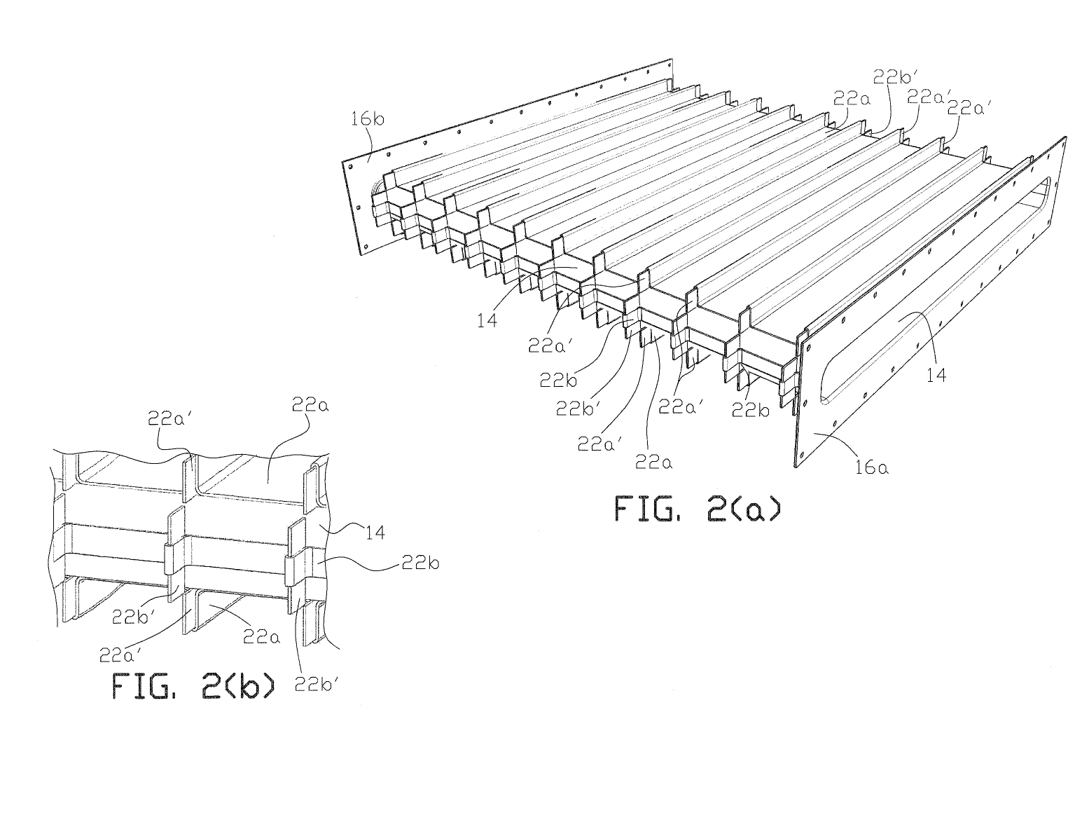

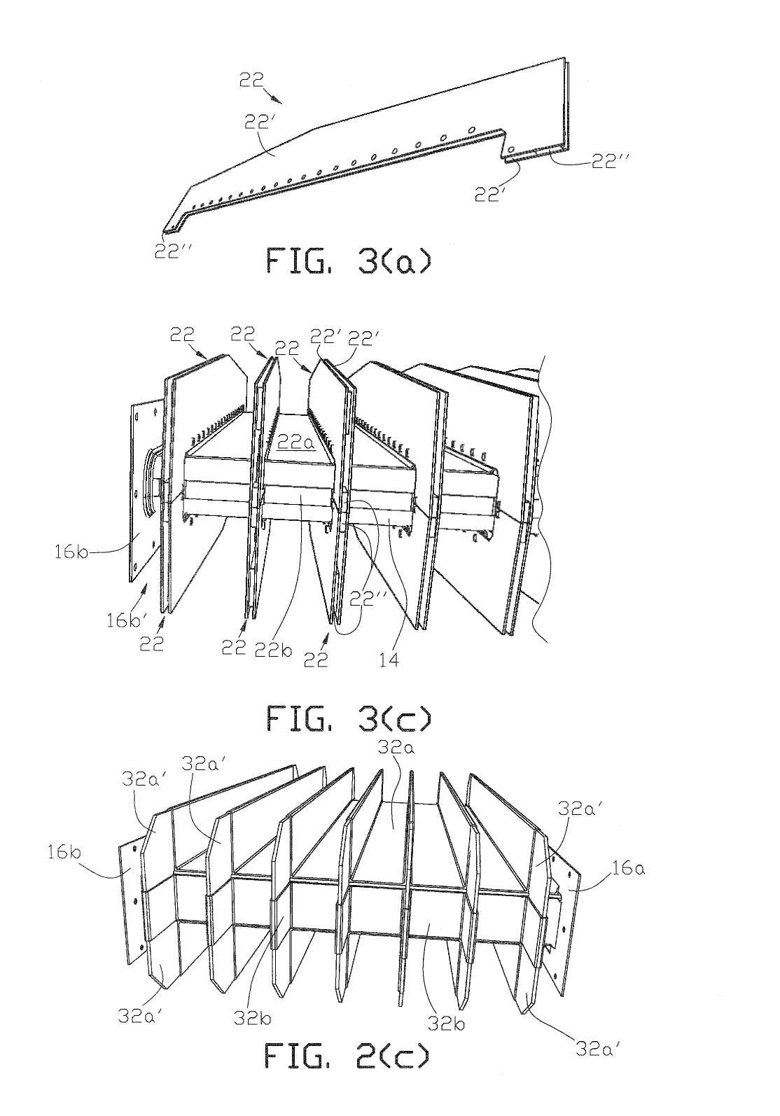

FIG. 2(a) and FIG. 2(b) illustrate components used in another example of an electric induction gas-sealed tunnel furnace of the present invention. In this example, the furnace can utilize tunnel wall 14 and sealing entry and exit flanges 16a and 16b shown in FIG. 1(a). In this example, the reinforcing (girding) structural elements that form a part of the tunnel reinforcement assembly comprise external longitudinal top and bottom girding sheets 22a; side girding sheets 22b (located on each opposing exterior side of tunnel wall 14); transverse top and bottom girding (slats or) strips 22a′ (running transversely between opposing sides of the tunnel); and side girding strips 22b′ as seen in FIG. 2(a) and FIG. 2(b). The longitudinal top and bottom, and side girding sheets are disposed between the entry and exit flanges 16a and 16b over the exterior of tunnel wall 14 as shown in the drawings. Transverse top and bottom girding strips 22a′ are periodically embedded within the top and bottom girding sheets, which sheets and strips are all connected to the exterior of tunnel wall 14 as generally described above to form the plurality of bands transversely girding the exterior of the gas-sealed furnace tunnel. Side girding strips 22b′ are periodically embedded in side girding sheets 22b and transversely aligned with the top and bottom girding strips as shown in the figures. At least one single turn inductor can be transversely disposed in the space between adjacent embedded girding strips except (optionally) in the spaces between one or more opposing girding strips and entry 16a and exit 16b end flanges at the entry and exit ends of the furnace for reasons that are generally explained above. As in other examples of the invention, optional (thermal expansion elements or) compensators can be provided at the entry and/or exit ends of the tunnel furnace to allow for thermal expansion and contraction in the axial (X) direction as generally described above. A metal strip will be inductively heated as it moves through the tunnel when the single turn inductor(s) are suitably connected to one or more AC power sources.

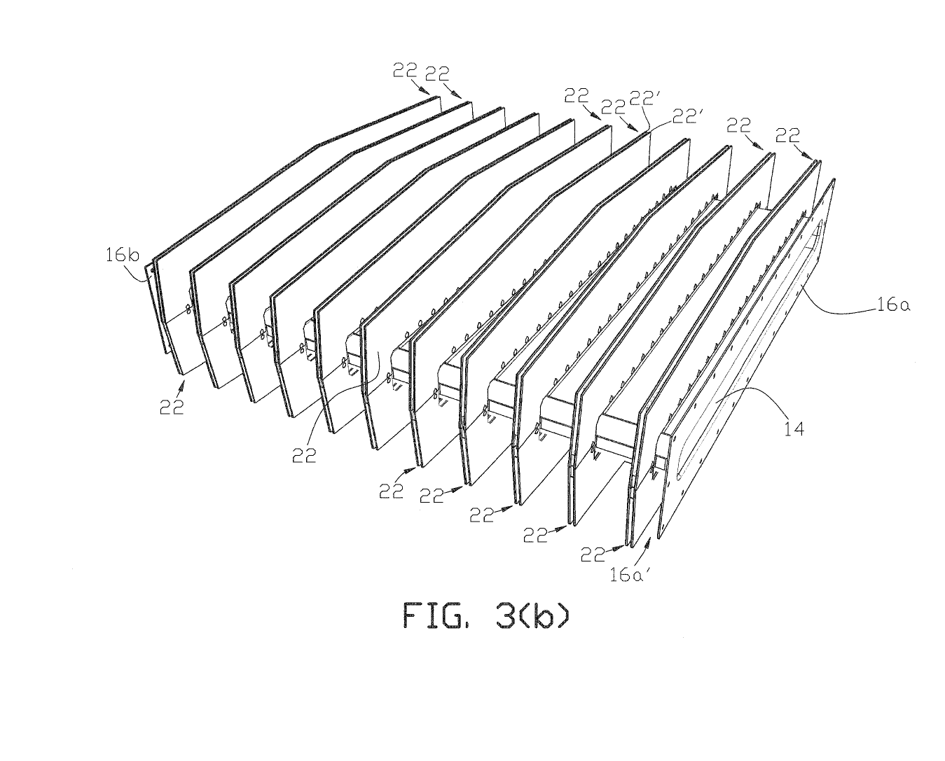

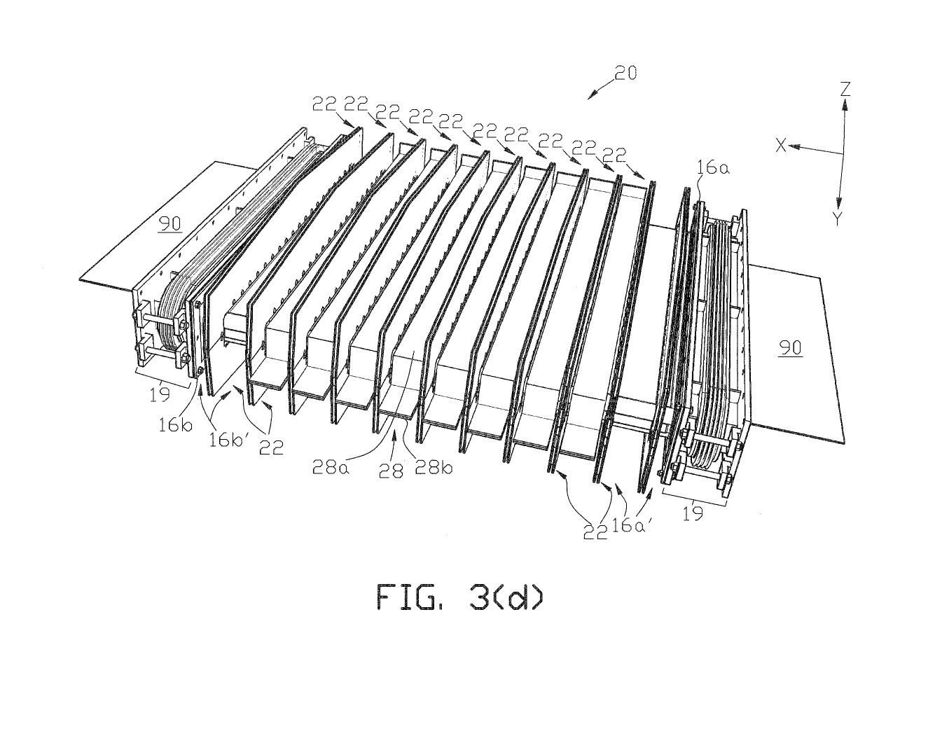

FIG. 3(a) through FIG. 3(d) illustrate another example of an electric induction gas-sealed furnace of the present invention that is referred to as the “modified example A” and is a modified furnace that utilizes furnace components shown in FIG. 2(a) and FIG. 2(b). External reinforcing structural elements 22 (FIG. 3(a)) are disposed transversely around the exterior of tunnel wall 14 over the sheet-embedded top, bottom and side girding strips as shown in FIG. 3(b), FIG. 3(c) and FIG. 3(d) to form a part of the plurality of bands that form a part of the tunnel reinforcement assembly. Each individual reinforcing structural element 22 comprises a pair of cut-out sheets 22′ that are offset from each other by spacer elements 22″ as shown in FIG. 3(a) so that the girding strips (beneath the girding sheets) fit into the space between the pair of offset and joined (by spacer elements 22″) cut-out sheets. An advantage of the modified example A furnace of the present invention over a furnace using the components in FIG. 2(a) and FIG. 2(b) is that reinforcing structural elements 22 serve to interconnect the top, bottom and side girding strips. At least one single turn inductor 28 is disposed in the space between adjacent reinforcing structural elements 22 as shown, for example, in FIG. 3(d), except (optionally) in the spaces 16a′ and 16b′ between one or more opposing end reinforcing structural elements 22 and entry 16a and exit 16b end flanges at the entry and exit ends of the furnace for reasons that are generally explained above. In this example of the invention, each single turn inductor comprises suitably interconnected upper 28a and lower 28b inductor sections that facilitate installation of each single turn inductor around the outside of the tunnel wall. Optional (thermal expansion elements or) compensators 19 (as shown in FIG. 3(d)) can be provided at the entry and/or exit ends of tunnel furnace 20 to allow for thermal expansion and contraction in the axial (X) direction as further described above. Metal strip 90 is shown in FIG. 3(d) as the workpiece passing through the tunnel furnace so that when the single turn inductor(s) are suitably connected to one or more AC power sources the metal strip will be inductively heated as it moves through the tunnel.

FIG. 2(c) illustrates one example of an electric induction gas-sealed tunnel furnace of the present invention that is referred to as the “modified example B” and is a modification of the example shown in FIG. 2(a) and FIG. 2(b). In FIG. 2(c) separate side girding (slats or) strips 22b′ utilized in the FIG. 2(a) and FIG. 2(b) example are eliminated, and the transverse top and bottom girding strips 22a′ are modified to form a unitary enclosing transverse girding strip 32a′ as shown in FIG. 2(c) that is periodically embedded in the top or bottom 32a and opposing sides (32b) girding sheets to form a part of the plurality of bands of the tunnel reinforcement assembly. Each unitary enclosing transverse girding strip 32a′ is similar in overall shape to entry and exit flanges 16a and 16b in that it encloses completely around a transverse section of the exterior tunnel wall. Each unitary enclosing transverse girding strip may be formed from a single cutout sheet that is slipped over the exterior of the tunnel wall during fabrication process. Alternatively each unitary enclosing girding strip may be formed from the combination of a top and bottom half cut-out sheet that are joined together around the exterior of the tunnel wall. An advantage of the modified example B furnace of the present invention over a furnace using the components in FIG. 2(a) and FIG. 2(b), or the example A furnace, is that fewer components are used and better rigidity of the girding structure is achieved. At least one single turn inductor can be transversely disposed in the space between adjacent embedded unitary enclosing transverse girding strips except (optionally) in the spaces between one or more opposing girding strips and entry 16a and exit 16b end flanges at the entry and exit ends of the furnace for reasons that are generally explained above. As in other examples of the invention, optional (thermal expansion elements or) compensators can be provided at the entry and/or exit ends of the tunnel furnace to allow for thermal expansion and contraction in the axial (X) direction as generally described above. A metal strip will be inductively heated as it moves through the tunnel when the single turn inductor(s) are suitably connected to one or more AC power sources.

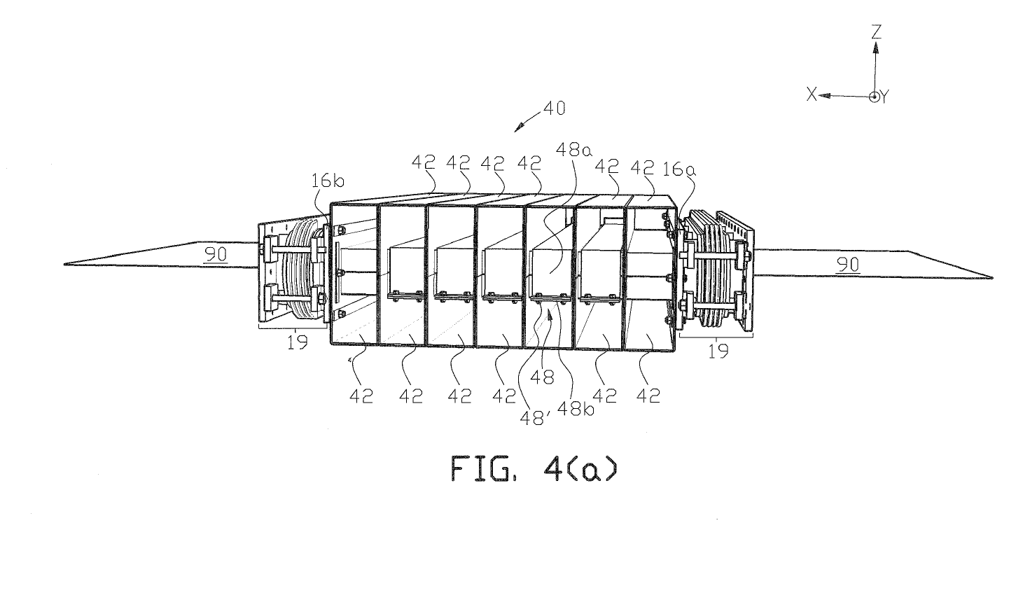

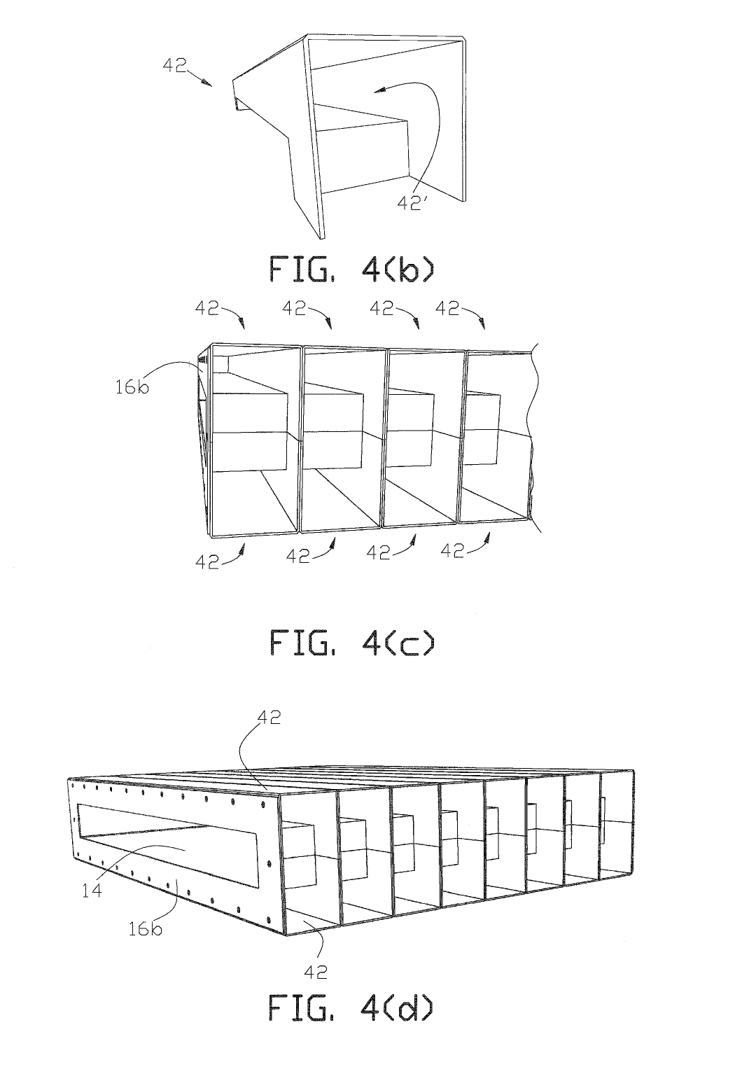

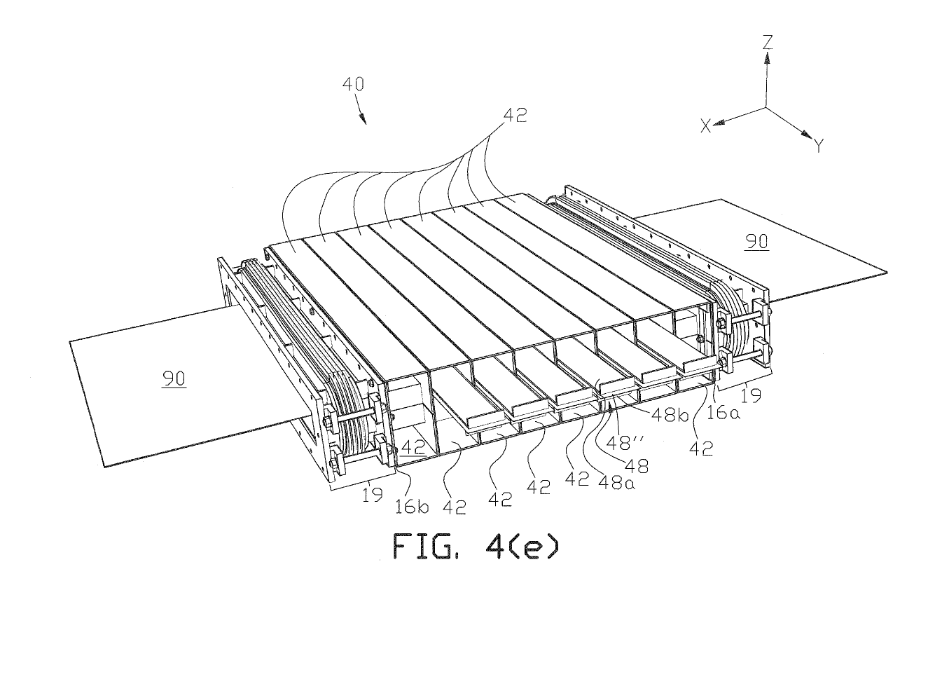

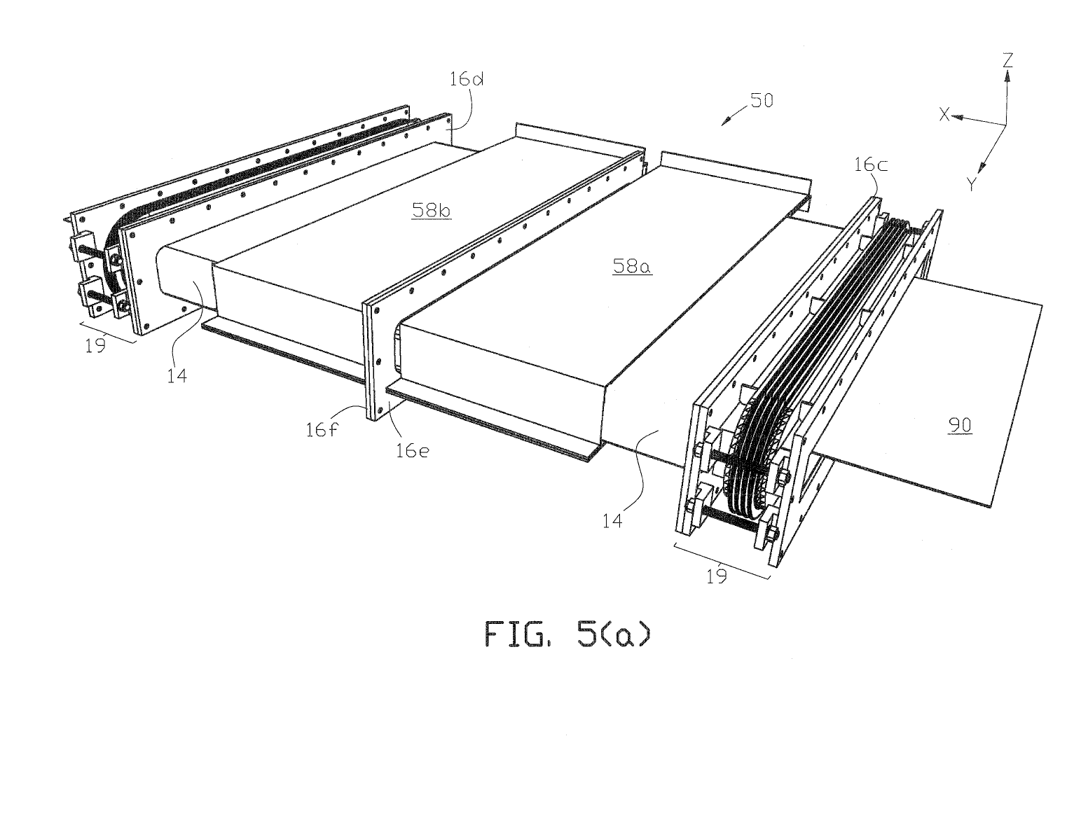

FIG. 4(a) through FIG. 4(e) illustrate another example of an electric induction gas-sealed tunnel furnace of the present invention. Furnace 40 (FIG. 4(e)) can utilize tunnel wall 14 and sealing entry and exit flanges 16a and 16b as shown in FIG. 1(a). In this example, a plurality of box-shaped transverse reinforcing (girding) elements 42 as best seen in FIG. 4(b), FIG. 4(c) and FIG. 4(d) are disposed around the upper and lower halves of the exterior of tunnel wall 14 between end flanges 16a and 16b as shown in FIG. 4(c) and FIG. 4(d) to form the plurality of bands transversely girding the exterior of the gas-sealed furnace tunnel of the tunnel reinforcement assembly. In this arrangement, at least one single turn inductor 48 is provided in the interior space 42′ formed by an opposing upper and lower pair of box-shaped transverse reinforcing elements 42 as shown in FIG. 4(a) and FIG. 4(e). The reinforcing elements 42 and the formed space 42′ within which the inductor is situated is rectangular in cross section in this example of the invention. In other examples of the invention, the cross section(s) (either of the reinforcing element and/or the interior space) may be of other shapes, such as semicircular. FIG. 4(a) and FIG. 4(e) show opposing sides of furnace 40 and illustrate how each inductor 48 may be formed from suitably interconnected upper 48a and lower 48b inductor sections that facilitate installation of the single turn inductor around the outside of the tunnel wall, as in other examples of the invention. As shown in FIG. 4(a), on a first side of the furnace, upper and lower inductor sections 48a and 48b are suitably joined together (for example by fasteners 48′) to establish an electrical connection between the upper and lower inductor sections. On the second opposing side of the furnace, as shown in FIG. 4(e), upper and lower inductor sections 48a and 48b are separated by an electrical insulator 48″ and suitably connected to one or more AC power sources so that metal strip 90 will be inductively heated as it passes through the tunnel. As in other examples of the invention, optional (thermal expansion elements or) compensators 19 (as shown in FIG. 4(a) and FIG. 4(e)) can be provided at the entry and/or exit ends of tunnel furnace 40 to allow for thermal expansion and contraction in the axial (X) direction as generally described above.

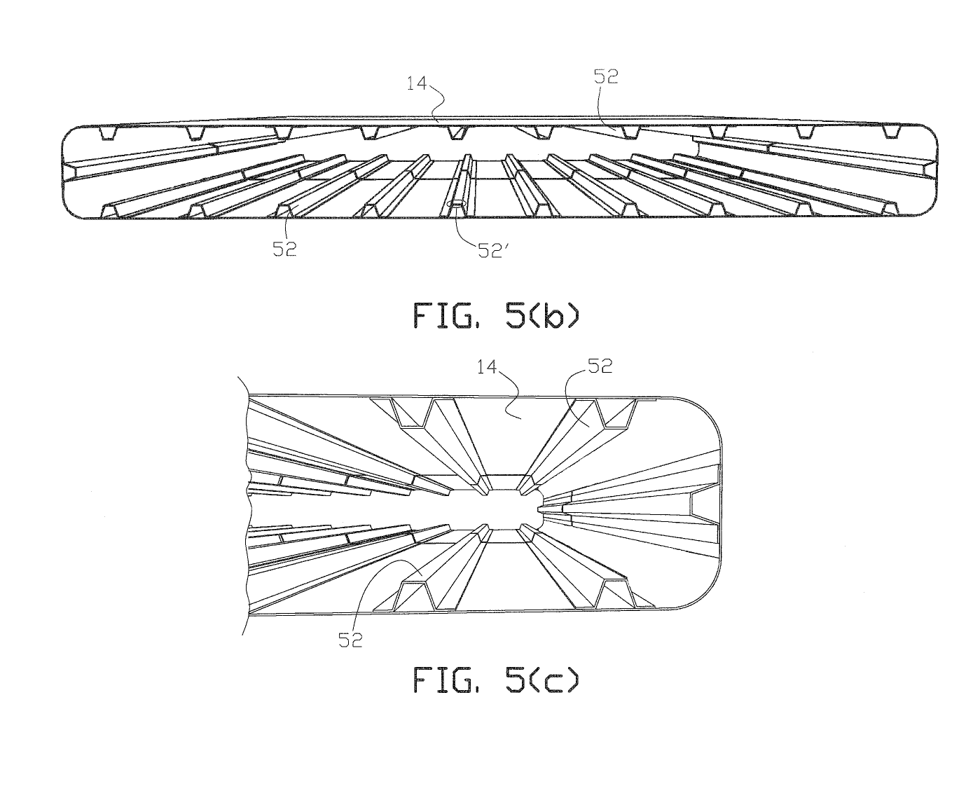

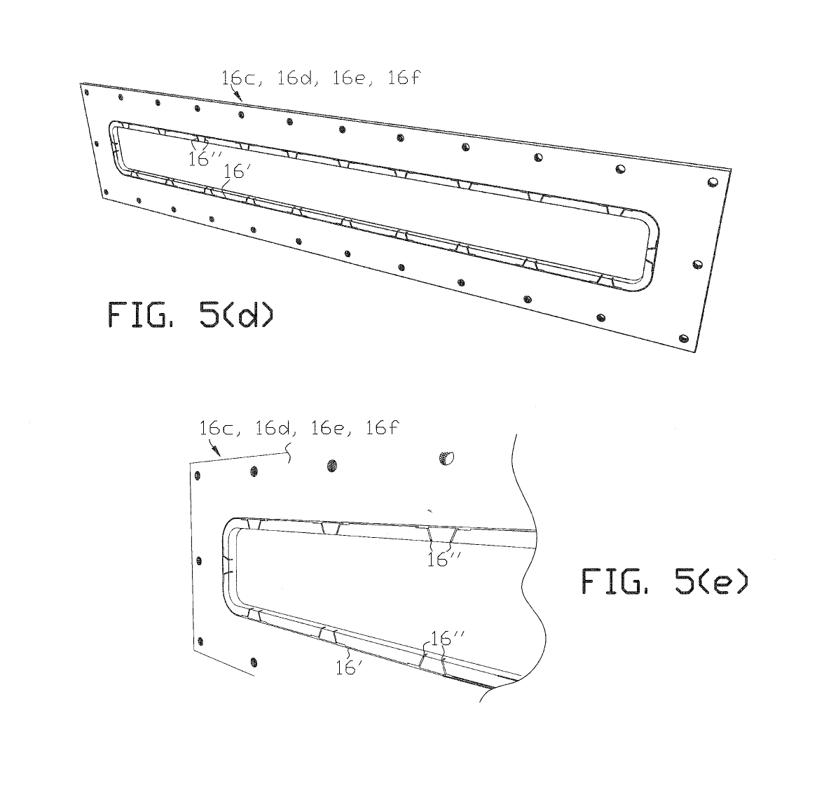

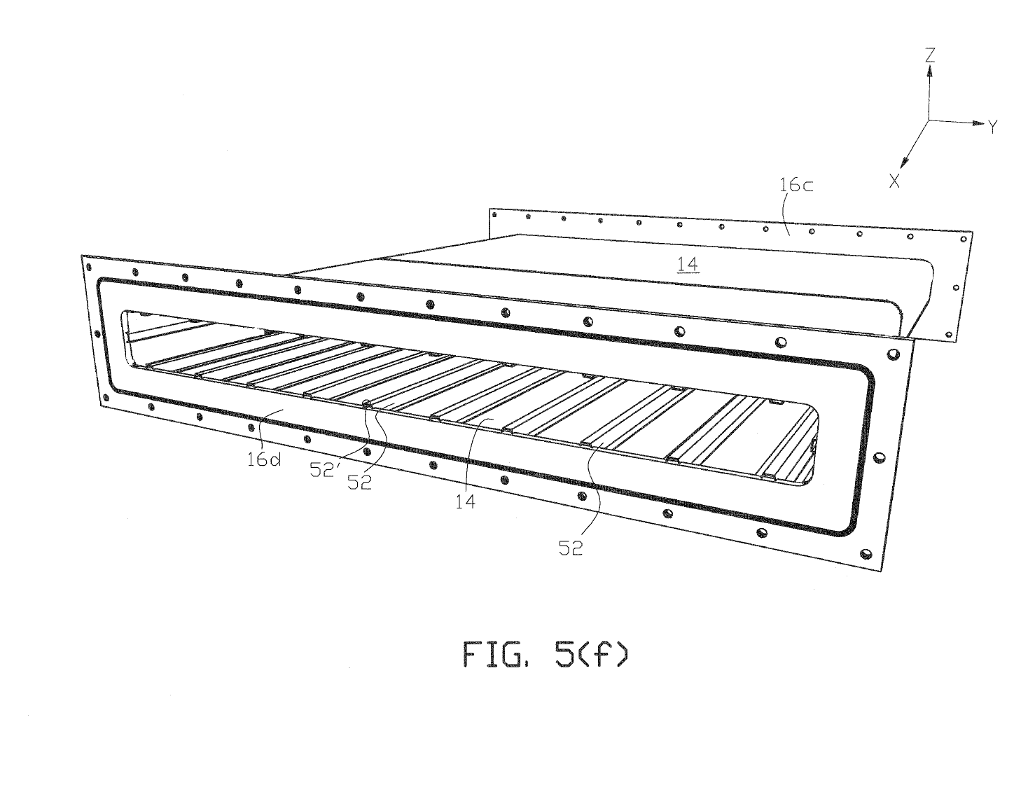

In the above examples of the invention, the structural reinforcing elements of the tunnel reinforcement assembly are located external to the tunnel wall of the furnace and include a plurality of reinforcing elements (bands) that are positioned transverse (Y-direction) to the length of the tunnel between the entry and exit end flanges. Transverse structural reinforcement is preferred since there is cancellation of forces between opposing top and bottom structural elements. In alternative examples of the invention, the plurality of reinforcing elements may be located internal to the tunnel wall of the furnace and/or include reinforcing elements that are longitudinally oriented the length of the tunnel between the opposing open ends of the furnace tunnel. For example, electric induction gas-sealed tunnel furnace 50 of the present invention shown in FIG. 5(a) utilizes a plurality of reinforcing structural elements 52 that are arranged longitudinally (X-direction) in a spaced apart configuration around the interior of tunnel wall 14 as shown in detail in FIG. 5(b) and FIG. 5(c). Interior reinforcing structural elements 52 are trapezoidal in cross section in this example of the invention. In other examples of the invention, other cross sectional shapes, such as rectangular, circular or semicircular may be used, and can be structural elements separate from the tunnel wall structure. Interior reinforcing structural elements 52 run along the length of the tunnel from the sealing entry 16c and exit 16d flanges. Optional central furnace flanges 16e and 16f are provided in this example; in other examples of the invention, other intermediate flanged sections may be provided to form a single furnace as required for a particular application. The flanges utilized in this example of the invention can be different from the flanges utilized in other examples of the invention described above in that each flange includes grooves or indentations 16′ and 16″ as seen in FIG. 5(d) and FIG. 5(e) for insertion of the end edges of tunnel wall 14 and reinforcing elements 52, respectively. Each flange can be formed from a suitable metal and machined with indentations 16′ and 16″ in which the interfacing end of the impregnated composite tunnel wall 14 and reinforcing structural elements 52 can be inserted to form a gas-tight seal between the flange and (1) the interfacing end of tunnel wall 14 and (2) reinforcing structural elements 52 around the interior of the wall. In this example of the invention the reinforcing elements 52 partially protrude into the interior of the tunnel and are not inserted into the flanges as illustrated by region 52′ in FIG. 5(f).

Two single turn inductors 58a and 58b surround the exterior of tunnel wall 14 and are situated on opposing sides of the central furnace flanges in this example of the invention. The inductors are suitably electrically interconnected and connected to one or more AC power sources so that metal strip 90 will be inductively heated as it passes through the tunnel. As in other examples of the invention, optional (thermal expansion elements or) compensators 19 (as shown in FIG. 5(a)) can be provided at the entry and/or exit ends of tunnel furnace 50 to allow for thermal expansion and contraction in the axial (X) direction as further described above.

If the tunnel reinforcement assembly is located inside of the furnace tunnel there is a preference (but not a requirement) for orienting the tunnel reinforcement components with the length of the furnace tunnel as shown in FIG. 5(a) through FIG. 5(c) as opposed to the traverse orientation shown in the examples with external tunnel reinforcement assemblies. With longitudinal internal orientation, the tunnel reinforcement components inside the tunnel can function as supporting guides for a strip moving through the tunnel, whereas with transverse internal orientation of these components there is the possibility that the components will interfere with movement of the strip through the tunnel.

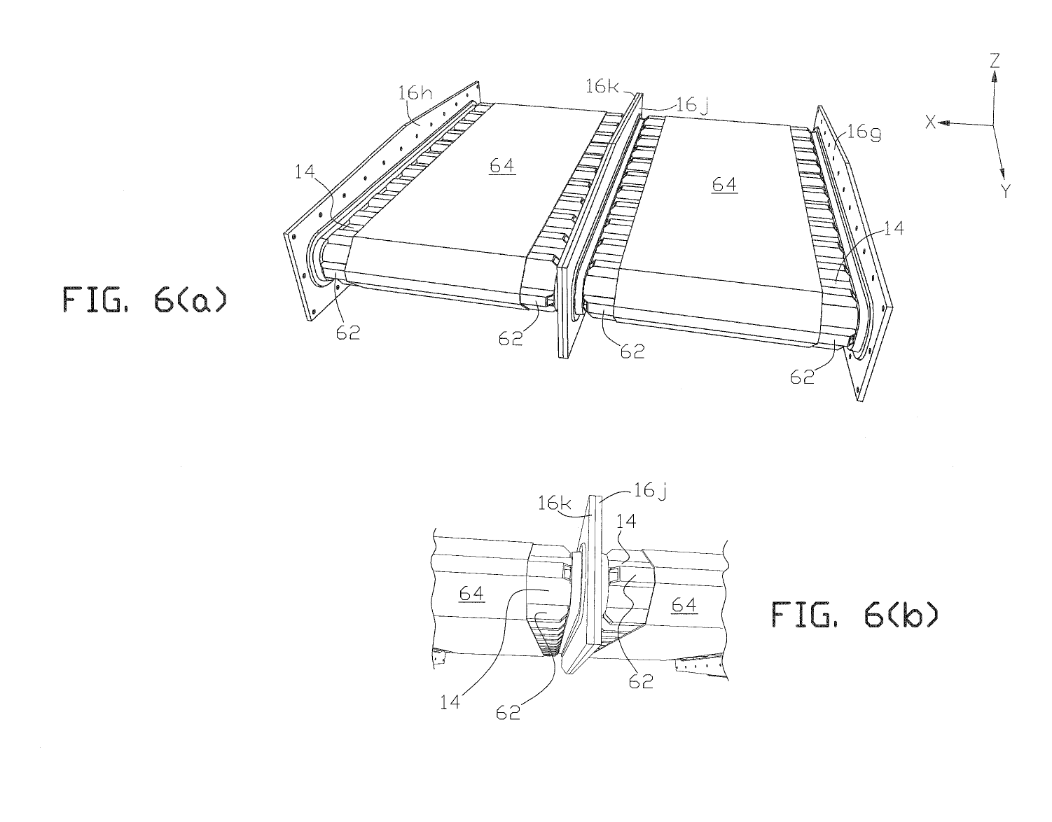

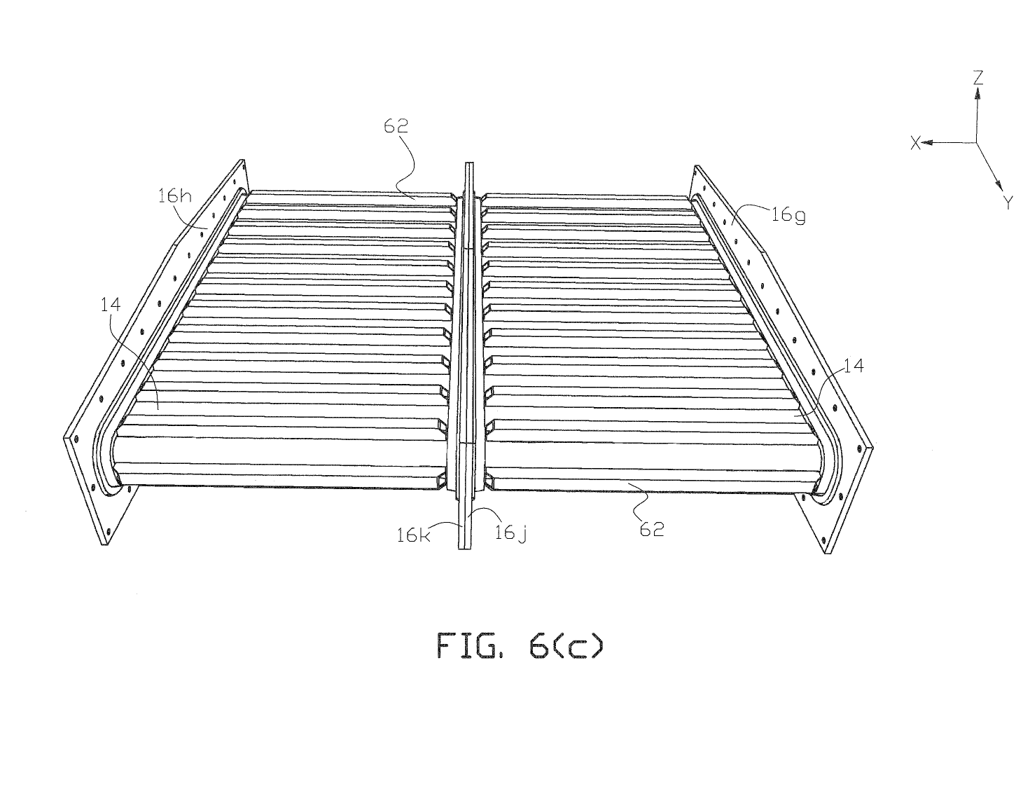

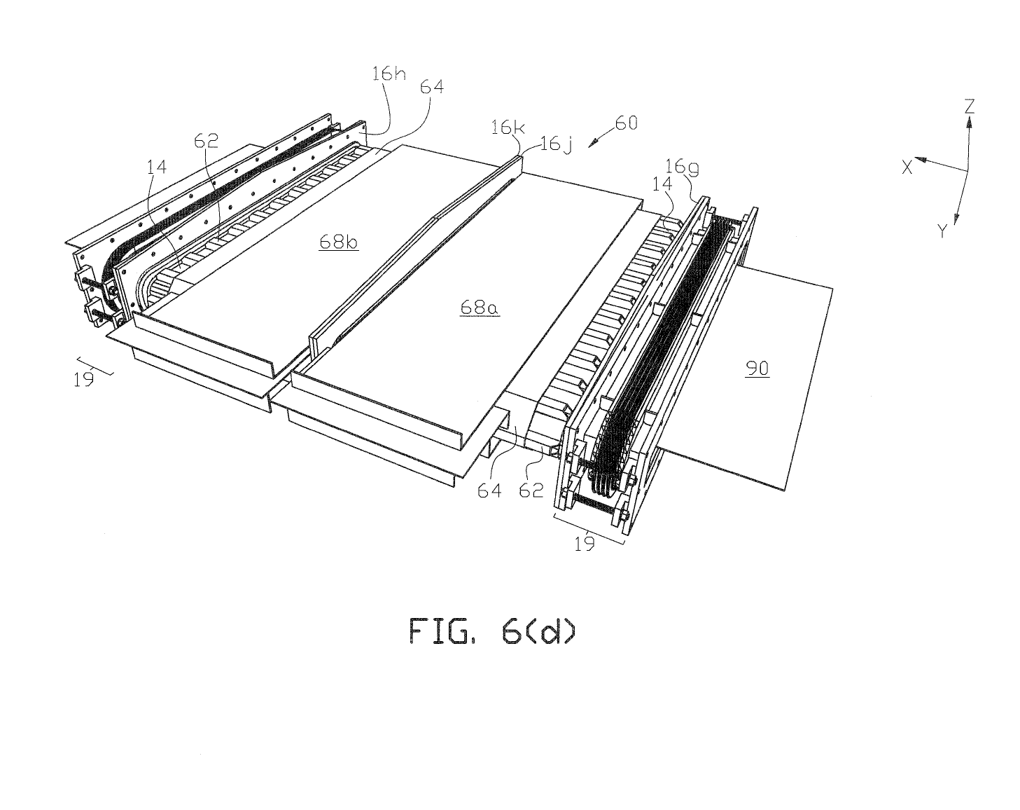

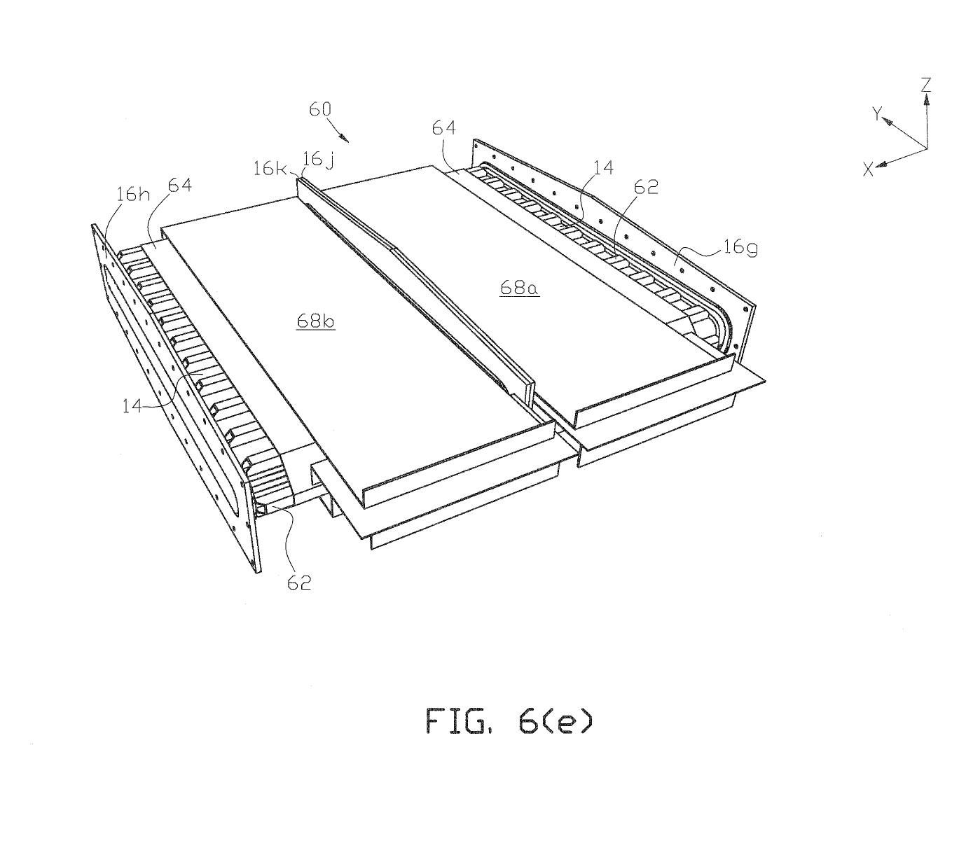

FIG. 6(a) through FIG. 6(e) illustrate another example of an electric induction gas-sealed tunnel furnace 60 of the present invention. This example is similar to tunnel furnace 50 shown in FIG. 5(a) except that longitudinally oriented reinforcing structural elements 62 of the tunnel reinforcement assembly are located on the exterior of tunnel wall 14. With this arrangement, the ends of tunnel wall 14 can be sealed with interfacing end flanges 16g and 16h, and optional central flanges 16j and 16k. Reinforcing (or girding) structural elements 64 wrap transversely around external longitudinally oriented reinforcing structural elements 62 as shown in FIG. 6(a), FIG. 6(d) and FIG. 6(e) to form a part of the tunnel reinforcement assembly. In the figures the girding wrap structural elements 64 are shown partially withdrawn from the ends of the furnace tunnel, and in other examples of the invention wrap structural elements 64 extend to the ends of the furnace tunnel.

Similar to the arrangement for furnace 50 in FIG. 5(a), two single turn inductors 68a and 68b surround the exterior of tunnel wall 14 and are situated on opposing sides of the central flanges in this example of the invention. The inductors are suitably electrically interconnected and connected to one or more AC power sources so that metal strip 90 will be inductively heated as it passes through the tunnel. As in other examples of the invention, optional (thermal expansion elements or) compensators 19 (as shown in FIG. 6(d)) can be provided at the entry and/or exit ends of tunnel furnace 60 to allow for thermal expansion and contraction in the axial (X) direction as further described above.

In other examples of the invention, a combination of both transverse and longitudinal reinforcing structural elements, either inside the tunnel wall, or external to the tunnel wall, may be used by combination of two or more of the examples of the invention set forth above.

While fiberglass (fiber) cloths are used to form the tunnel and reinforcing structures in the above examples of the invention, other materials may be used as long as they are at least partially transparent to an electromagnetic field as required to allow electromagnetic flux coupling with the workpiece (such as a strip) passing axially through the tunnel and to avoid undesired flux coupling (induced heating) from current flow through the furnace's inductor(s). Generally the compositions of the tunnel wall and reinforcing structures should: (1) be of low porosity at least in regions where gaseous permeability from the interior/exterior of the tunnel wall is a consideration; (2) be of thermal compatibility with the temperatures within the heated tunnel to withstand thermal degradation in a particular process environment; and (3) not emit or propagate (for example, residual process solvent) emission of a gas or liquid that would negatively affect the workpiece (strip) processing within the tunnel.

In all examples of the invention additional external components may be installed external to the furnace. For example an electromagnetic shield may extend around the external length of furnace.

In all examples of the invention thermal control features, such as passive thermal insulation and/or active thermal control apparatus such as heating or cooling fluid passages can be provided internal or external to the furnace tunnel wall as required for thermal control within the tunnel for a particular application.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A reinforced electric induction gas-sealed tunnel furnace for inductively heating a strip material, the reinforced electric induction gas-sealed tunnel furnace comprising:
a gas-sealed furnace tunnel sealable at opposing open tunnel ends, through which open tunnel ends the strip material enters and exits the gas-sealed furnace tunnel, the gas-sealed furnace tunnel formed at least partially from an electromagnetically transparent material;
a tunnel reinforcement assembly formed at least partially from an electromagnetically transparent material, the tunnel reinforcement assembly attached to the gas-sealed furnace tunnel; and
at least one electric inductor for inductively heating the strip material as the strip material passes through the gas-sealed furnace tunnel.

2. The reinforced electric induction gas-sealed tunnel furnace of claim 1 wherein the tunnel reinforcement assembly comprises a plurality of bands traversely girding the exterior of the gas-sealed furnace tunnel.

3. The reinforced electric induction gas-sealed tunnel furnace of claim 2 wherein the plurality of bands are spaced apart from each other to form one or more inductor seating volumes for the at least one electric inductor within the tunnel reinforcement assembly.

4. The reinforced electric induction gas-sealed tunnel furnace of claim 3 wherein each one of the plurality of bands comprises:
a top and bottom cut-out sheet; and
a plurality of top, bottom and sides “L” shaped reinforcing elements connecting the top and bottom cut-out sheets to the top, bottom and sides of the gas-sealed furnace tunnel.

5. The reinforced electric induction gas-sealed tunnel furnace of claim 3 wherein each one of the plurality of bands comprises:
a top girding strip disposed under a top girding sheet disposed longitudinally over the top of the gas-sealed furnace tunnel;
a bottom girding strip disposed under a bottom girding sheet disposed longitudinally over the bottom of the gas-sealed furnace tunnel; and
a side girding strip disposed under a side girding sheet on each opposing side of the gas-sealed furnace tunnel, each side girding sheet disposed longitudinally over the side of the gas-sealed furnace tunnel.

6. The reinforced electric induction gas-sealed tunnel furnace of claim 3 wherein each one of the plurality of bands comprises a unitary enclosing transverse girding strip disposed under a top, bottom and sides girding sheets disposed longitudinally over the top, bottom and sides, respectively, of the gas-sealed furnace tunnel.

7. The reinforced electric induction gas-sealed tunnel furnace of claim 5 wherein each one of the plurality of bands further comprises:
a top spaced apart pair of cut-out sheets disposed over the top girding strip under the top girding sheet and partially over the opposing sides' girding strips under the opposing sides' girding sheets; and
a bottom spaced apart pair of cut-out sheets disposed over the bottom girding strip under the bottom girding sheet and partially over the opposing sides' girding strips under the opposing sides' girding sheets.

8. The reinforced electric induction gas-sealed tunnel furnace of claim 3 wherein each one of the plurality of bands comprises a top and bottom girding box forming an internal box volume for the at least one electric inductor.

9. The reinforced electric induction gas-sealed tunnel furnace of claim 1 wherein the tunnel reinforcement assembly comprises a plurality of reinforcing elements disposed longitudinally around the exterior of the gas-sealed furnace tunnel between the open opposing tunnel ends.

10. The reinforced electric induction gas-sealed tunnel furnace according to claim 1 further comprising a thermal compensator connected to at least one of the opposing open tunnel ends.

11. The reinforced electric induction gas-sealed tunnel furnace of claim 1 wherein the tunnel reinforcement assembly comprises a plurality of reinforcing structural elements disposed longitudinally around the interior perimeter of the reinforced electric induction gas-sealed furnace tunnel, the reinforced electric induction gas-sealed tunnel furnace further comprising a sealing entry flange and a sealing exit flange at the opposing open tunnel ends, the opposing ends of the plurality of reinforcing elements terminating within the sealing entry and exit flanges.

12. The reinforced electric induction gas-sealed tunnel furnace according to claim 11 further comprising a thermal compensator connected to at least one of the opposing open tunnel ends.

13. A method of forming a structurally reinforced electric induction gas-tight tunnel furnace for inductively heating a strip material, the method comprising the steps of:
forming an at least partially electromagnetically transparent gas-tight furnace tunnel for the strip material to pass within the gas-tight furnace tunnel;
forming an at least partially electromagnetically transparent tunnel reinforcement assembly;
attaching the tunnel reinforcement assembly to the gas-tight furnace tunnel; and
surrounding the exterior of the gas-tight furnace tunnel with at least one electric inductor.

14. The method of claim 13 wherein:
the step of forming the at least partially electromagnetically transparent gas-sealed furnace tunnel comprises:
forming a tunnel fiberglass fiber material around a tunnel mold;
and curing the tunnel fiberglass fiber material on the tunnel mold;
the step of forming the at least partially electromagnetically transparent tunnel reinforcement assembly comprises:
forming a plurality of tunnel fiberglass fiber material reinforcing structural elements with one or more tunnel reinforcement molds;
curing the plurality of tunnel fiberglass fiber material reinforcing structural elements on the one or more tunnel reinforcement molds; and
removing the plurality of tunnel fiberglass fiber material reinforcing structural elements from the one or more tunnel reinforcement molds;
the step of attaching the tunnel reinforcement assembly to the gas-tight furnace tunnel comprises the steps of:
assembling the plurality of cured tunnel fiberglass fiber material reinforcing structural elements into the tunnel reinforcement assembly on the cured tunnel fiberglass fiber material;
resin impregnating the combination of the tunnel reinforcement assembly on the cured tunnel fiberglass fiber material; and
removing the tunnel mold from the resin impregnated combination of the tunnel reinforcement assembly on the cured tunnel fiberglass fiber material.

15. The method of claim 14 wherein the step of assembling the plurality of cured tunnel fiberglass fiber material reinforcing structural elements into the tunnel reinforcement assembly on the cured tunnel fiberglass fiber material further comprises transversely orienting the plurality of tunnel fiberglass fiber material reinforcing structural elements on the cured tunnel fiberglass fiber material.

16. The method of claim 15 wherein the step of surrounding the exterior of the gas-tight furnace tunnel with at least one electric inductor further comprises locating the at least one electric inductor between the transversely oriented plurality of tunnel fiberglass fiber material reinforcing structural elements.

17. The method of claim 14 wherein the step of assembling the plurality of cured tunnel fiberglass fiber material reinforcing structural elements into the tunnel reinforcement assembly on the cured tunnel fiberglass fiber material further comprises longitudinally orienting the plurality of tunnel fiberglass fiber material reinforcing structural elements on the exterior of the cured tunnel fiberglass fiber material.

18. The method of claim 14 further comprising the step of assembling the plurality of cured tunnel fiberglass fiber material reinforcing structural elements into the tunnel reinforcement assembly on the cured tunnel fiberglass fiber material further comprises longitudinally orienting the plurality of tunnel fiberglass fiber material reinforcing structural elements on the interior of the cured tunnel fiberglass fiber material.

19. The method of claim 18 further comprising the step of sealing the opposing ends of the each of the plurality of tunnel fiberglass fiber material reinforcing structural elements to a sealing entry flange and a sealing exit flange at the opposing ends of the tunnel fiberglass fiber material.

20. A method of inductively heating a strip material comprising the steps of:
passing the strip material through an at least partially electromagnetically transparent gas-sealed furnace tunnel sealed at opposing open tunnel ends and reinforced with an at least partially electromagnetically transparent tunnel reinforcement assembly;
locating at least one electric inductor around the at least partially electromagnetically transparent reinforcement assembly; and
supplying an alternating current to the at least one electric inductor to inductively heat the strip material passing through the at least partially electromagnetically transparent gas-sealed furnace tunnel.
